(19) United States
(12) Patent Application Publication
(10) Pub. No.: US 2009/0259737 A1
(43) Pub. Date: Oct. 15, 2009

(54) ADMINISTRATION SYSTEM AND ADMINISTRATION METHOD FOR COMPUTERS

(76) Inventors: Kazuhide AIKOH, Yokohama (JP); Keisuke Hatasaki, Kawasaki (JP); Yoko Shiga, Yokohama (JP)

Correspondence Address: BRUNDIDGE & STANGER, P.C., 1700 DIAGONAL ROAD, SUITE 330, ALEXANDRIA, VA, 22314, US

(21) Appl. No.: 12/324,940

(22) Filed: Nov. 28, 2008

(30) Foreign Application Priority Data
Apr. 11, 2008 (JP) 2008-103286

(51) Int. Cl. G06F 15/177

(52) U.S. Cl. 709/221

(57) ABSTRACT

Reconfiguration plans that cope with various events are produced for a computer system. An administration system for computers and an administration method for computers in accordance with the present invention have a constitution described below. A server system includes plural servers, and a management server that administers the server system is connected to the server system. The management server monitors an event occurring in the server system, produces reconfiguration plans for the server system on the basis of priorities assigned to the plural servers and/or application programs according to the monitored event, selects a reconfiguration plan from the reconfiguration plans under predetermined criteria for selection, and reconfigures the server system according to the selected reconfiguration plan.

### CLAIM PRIORITY

This application claims priority from Japanese patent application, JP 2008-103286 filed on Apr. 11, 2008 the content of which is hereby incorporated by reference into this application.

### BACKGROUND OF THE INVENTION

The present invention relates to an administration system and administration method for computers, or more particularly, to dynamic employment of computer resources.

In recent years, a server virtualization technology intended to effectively utilize computer resources has attracted attention. The server virtualization technology is such that: a resource of a physical server including a processor and a memory is logically divided into portions; and the portions are allocated to different virtual servers in order to implement plural virtual server computers in the physical server computer. Hereinafter, the server computer shall be simply called a server.

A server migration technology has also attracted attention. An operating system (OS) resident in a certain physical server and a program to be run on the OS are migrated into other physical server. A virtual server (a virtual OS and a program to be run on the virtual OS) resident in a certain physical server is migrated to be a virtual server resident in other physical server. The migration technology is used to integrate a computer system, which is implemented by plural physical servers, into a smaller number of physical servers, balance loads incurred by respective physical servers through migration of a virtual server, and make a computer system highly available through migration of a virtual server in case of a failure in a certain physical server. As an example of arrangement of virtual servers in physical servers within such a computer system, a method of rearranging virtual servers according to the operating situations of computers is described in U.S 2006/0069761 A1.

On the other hand, a demand for a highly reliable computer system is increasing. The dependency of corporations or the like on a computer system has grown, and a loss or a social impact caused by stop of the computer system has become serious. There is a technology according to which: an auxiliary server is made available in addition to an ongoing server for the purpose of realizing the highly reliable computer system; and if the ongoing server fails, the ongoing server is replaced with the auxiliary server.

JP-A-2006-163963 has disclosed a technology according to which: an ongoing server that is executing a job and an auxiliary server that does not execute any job are employed; if the ongoing server fails, a boot disk containing an OS is reloaded into the auxiliary server in order to start the auxiliary server; and the job is taken over by the auxiliary server.

### SUMMARY OF THE INVENTION

The technology disclosed in U.S. Pat. No. 20,060,069,761 is to migrate a virtual server resident in a high-load physical server into a low-load physical server (a physical server having a sufficient amount of resources) in order to balance loads, and makes it a precondition that a computer system has a sufficient amount of resources as a whole. The technology disclosed in JP-A-2006-163963 needs the auxiliary server that executes no job, and also makes it a precondition that a computer system has a sufficient amount of resources.

From the viewpoint of construction of a computer system, although high reliability is a mandatory requirement, an excess (redundancy) of resources has to be confined to a minimum necessary level. Even when a computer system is constructed with the sufficiency in the amount of resources, the necessity of coping with occurrence of a multiple failure or meeting a request for intensified power saving arises, and the necessity of testing or deploying a new program that uses a larger amount of resources than an excess of resources arises. In U.S. Pat. No. 20,060,069,761 and JP-A-2006-163963, measures are not taken against such a situation.

An administration system and administration method for computers in accordance with the present invention are constituted as mentioned below. A server system includes plural servers, and a management server that administers the server system is connected to the server system. The management server monitors an event occurring in the server system, produces reconfiguration plans for the server system on the basis of the priorities of the plural servers and/or application programs according to the monitored event, selects a reconfiguration plan from the reconfiguration plans under predetermined criteria for selection, and reconfigures the server system according to the determined reconfiguration plan.

In another aspect of the present invention, at least one of servers included in the server system is a virtual server that operates in a physical server.

In still another aspect of the present invention, the selected reconfiguration plan includes migration of at least one of the plural servers and/or application programs.

In still another aspect of the present invention, the predetermined criteria include at least one of (1) a criterion that the number of servers and/or application programs to be migrated should be small and (2) a criterion that the number of servers being continuously run should be large.

In still another aspect of the present invention, the priorities are relatively determined based on jobs to be executed by the plural servers and/or application programs included in the server system.

In still another aspect of the present invention, the monitored event is at least one of a failure of a physical server included in the server system, an instruction of power saving in the server system, and an instruction of new deployment.

According to the present invention, reconfiguration plans (cases) coping with various events can be produced for a computer system in which an excess (redundancy) of resources is confined to a minimum necessary level. When criteria for selection are applied to the reconfiguration plans, the plural reconfiguration plans can be easily compared with one another. Eventually, an appropriate reconfiguration plan conformable to the criteria for selection can be obtained.

### BRIEF DESCRIPTION OF THE DRAWINGS

FIG. 1 shows an example of the configuration of a computer system;

FIG. 2 is a configuration information table;

FIG. 3A and FIG. 3B are priority information tables;

FIG. 4 is a flowchart presenting processing performed by a management server;

FIG. 5 is a flowchart presenting server arrangement processing;

FIG. 6 is an example of a server arrangement list;

FIG. 7 shows a processing sequence for producing the server arrangement list;

FIG. 8 is an example of the server arrangement list;

FIG. 9 is an example of the server arrangement list; and

FIG. 10 is an example of the server arrangement list.

### DESCRIPTION OF THE PREFERRED EMBODIMENTS

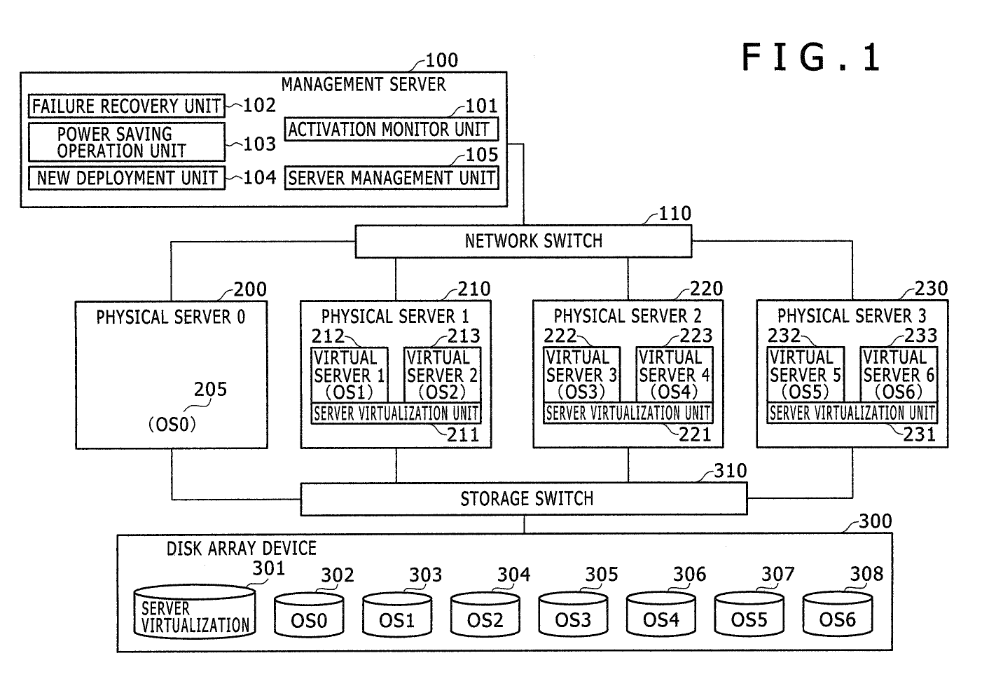

An embodiment of the present invention will be described in conjunction with the drawings. FIG. 1 shows an example of the configuration of a computer system of the present embodiment. The system configuration includes a management server 100, physical servers 0 to 3 (200, 210, 220, and 230), and a disk array device 300. The management server 100 is a server that is connected to a server system composed of the physical servers 0 to 3 (200, 210, 220, and 230) via a network switch 110 and that is intended to manage the server system. The disk array device 300 is an external storage device which is connected to the physical servers 0 to 3 (200, 210, 220, and 230) via a storage switch 310 and in which an OS, a job control program, and job data which the server system needs to operate are stored. Moreover, a server virtualization program which the physical servers require for activating virtual servers, and OSs for the virtual servers (virtual OSs) are stored in the disk array device 300.

FIG. 1 shows the configuration in which the management server 100 and physical servers 0 to 3 (200, 210, 220, and 230) are connected to one another via the network switch 110. The present invention is not limited to the network switch 110. Alternatively, the management server 100 and physical servers 0 to 3 may be connected to one another over a LAN or the like. Moreover, a storage area network (SAN) composed of the storage switch 310 and disk array device 300 is shown. Alternatively, a mere disk device will do as long as the aforesaid OS and job control program are stored therein and are accessible by the server system.

The management server 100 includes an activation monitor unit 101, a failure recovery unit 102, a power saving operation unit 103, a new deployment unit 104, and a server arrangement unit 105. Although these units are separately introduced for a better understanding, they may be implemented as one united body or may be arbitrarily separated for convenience in mounting. A description will be made of processing to be performed by a series of programs.

The activation monitor unit 101 monitors the operating situation of the server system composed of the physical servers 0 to 3 (200, 210, 220, and 230). The operating situation to be monitored encompasses a load and a failure. The activation monitor unit 101 receives a command entered by a manager who manages the operation of the server system, and executes processing associated with the command. The illustration and description of an input device via which a command is received and an output device to be used to notify the result of command execution are omitted.

The failure recovery unit 102 discriminates a physical server, in which a failure has occurred, during failure sensing performed on the server system by the activation monitor unit 101, and puts the server arrangement unit 105 into operation. The power saving operation unit 103 discriminates a physical server, of which power supply should be turned off, in response to a power saving operation instruction sent from the activation monitor unit 101, and puts the server arrangement unit 105 into operation. The power saving operation instruction is inputted as a command to the management server 100, and carries information with which the physical server whose power supply should be turned off is identified. The new deployment unit 104 discriminates a resource in which a program to be newly deployed runs, and puts the server arrangement unit 105 into operation. A deployment instruction is inputted as a command to the management server 100, and carries information with which the resource in which the program to be deployed operates is identified.

The physical server 0 (200) of the server system operates as a physical server under the control of the OS 0 (205). The OS 0 (205) is an OS started using a startup disk 302 which is included in the disk array device 300 and in which the OS 0 is stored. The startup disk 302 is a disk (disk volume) in which the OS 0 is stored. When a loader (not shown) installed in the form of software or firmware in the physical server 0 (200) reads the OS 0 into a main memory unit (not shown) of the physical server 0 (200), and initiates running of the read OS 0, it says that the OS 0 is started or the physical server 0 (200) is started. Hereinafter, the startup disk is used for this purport.

In the physical server 1 (210), a virtual server 1 (212) in which an OS 1 is installed and a virtual server 2 (213) in which an OS 2 is installed operate. A server virtualization unit 211 is started using a startup disk 301 that is included in the disk array device 300 and that is used for server virtualization, and controls the virtual server 1 (212) and virtual server 2 (213).

The server virtualization unit 211 may be called a virtual machine monitor (VMM), a hypervisor, or a virtualization mechanism. The server virtualization unit 211 may be implemented in software. From the viewpoint of high performance, the server virtualization unit 211 may be implemented in software and firmware to which the facilities thereof are assigned. The OS 1 in the virtual server 1 (212) is an OS started using a startup disk 303 which is included in the disk array device 300 and in which the OS 1 is stored. The OS 2 in the virtual server 2 (213) is an OS started using a startup disk 304 which is included in the disk array device 300 and in which the OS 2 is stored.

In the case of the virtual server 1 (212), a loader (not shown) resident in the physical server 1 (210) reads the server virtualization unit 211 from the startup disk 301 for server virtualization. Another loader included in the server virtualization unit 211 reads the OS 1 from the startup disk 303, and reads the OS 2 from the startup disk 304. The OS 1 and OS 2 start (or produce) the virtual server 1 (212) and virtual server 2 (213) respectively.

A server virtualization unit 221, a virtual server 3 (222), and a virtual server 4 (223) resident in the physical server 2, and relevant startup disks 301, 305, and 306 as well as a server virtualization unit 231, a virtual server 5 (232), and a virtual server 6 (233) resident in the physical server 3, and relevant startup disks 301, 307, and 308 are identical to those resident in the physical server 1 and those relevant thereto. Herein, as the server virtualization units 211, 221, and 231 of the physical servers 1 to 3, the same server virtualization unit is described to be read from the startup disk 301 for server virtualization. Alternatively, server virtualization startup disks may be made available for the respective physical servers, and different server virtualization units may be stored in the respective startup disks.

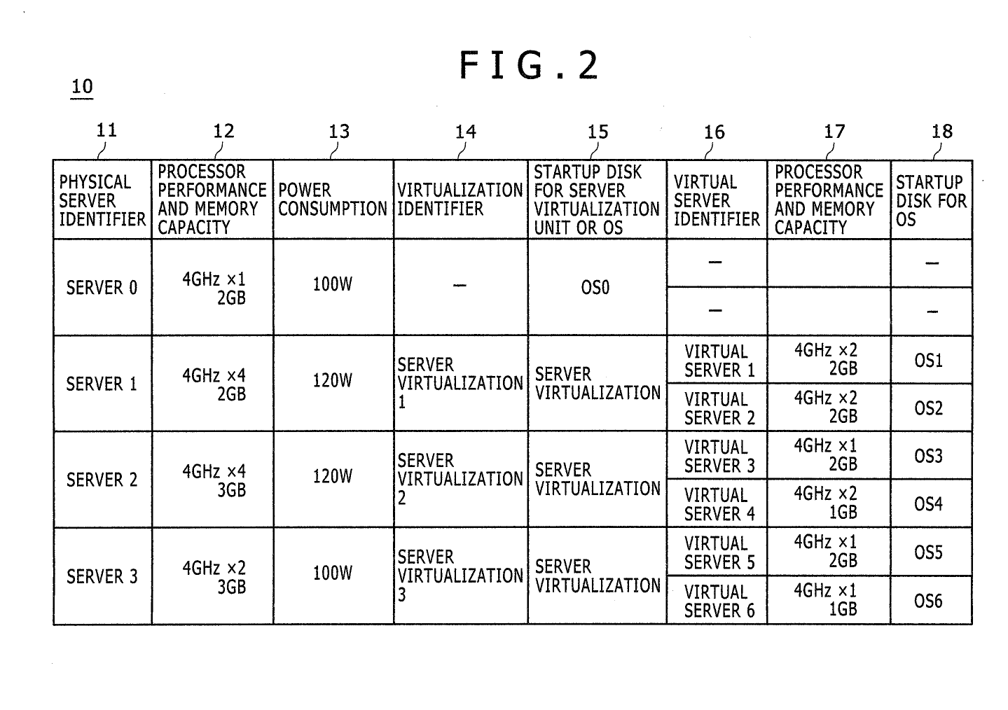

FIG. 2 shows a configuration information table 10 concerning the system configuration shown in FIG. 1. The configuration information table 10 is stored in a memory unit (not shown) in the management server 100. The management server 100 may include the disk array device 300 as an external storage device.

The configuration information table 10 includes columns for a physical server name (identifier) 11, a processor performance and memory capacity 12 representative of a resource for a physical server, a power consumption 13 of the physical server, a virtualization identifier 14 of a server virtualization unit, a startup disk 15 for the server virtualization unit or a startup disk 15 for an OS in the physical server, a virtual server identifier 16, a processor performance and memory capacity 17 representative of a resource for the virtual server, and a startup disk 18 for an OS in the virtual server. The processer performance is indicated with a clock frequency for processors, and the number of processors having the performance. The examples of names and numerical values specified in the configuration information table 10 express the system configuration shown in FIG. 1, and will be used to describe operations later. Herein, the details are omitted.

The representative of a resource for a physical server or a virtual server is not limited to the processor performance and memory capacity but may be the number of input/output devices or storage devices (disk volumes) to be connected and the performance thereof, or the number of communication interfaces to be connected onto a network and the performance thereof. Herein, for brevity's sake, the processor performance and memory capacity is adopted to represent the resource. The input/output devices and communication interfaces are taken into consideration as described below.

In relation to the present embodiment, a description will be made of rearrangement of physical servers and/or virtual servers for various events, or in other words, reallocation of resources to the physical servers and/or virtual servers (reconfiguration of a computer system). Namely, not only the physical servers and/or virtual servers are stopped but also the virtual servers are migrated. The precondition for migration is that a resource needed by an operating virtual server should be preserved in a migrational destination.

A virtual server must be able to access any of the disks (volumes) in the disk array device 300 in the same manner between before and after the virtual server is migrated. If the virtual server cannot access any of the disks, the virtual server is copied or migrated to an accessible disk (volume). Some disk array devices 300 have a facility that permits only a specific host computer (physical server or virtual server) to access a specific disk (volume) for the purpose of security guaranty. Herein, it is a precondition that the host computers (physical servers or virtual servers) in the system configuration shown in FIG. 1 should be able to share disks (volumes).

Likewise, it is a precondition that the aforesaid input/output device and communication interface should be preserved in a migrational destination. Namely, when a system that is larger in scale than the system configuration shown in FIG. 1 has the components thereof thinned so that the system will include components which satisfy resource conditions for disks (volumes) or input/output devices that are satisfactory migrational destinations, the system configuration shown in FIG. 1 ensues. The configuration information table 10 lists processor performances and memory capacities representing resources that are not thinned out. An idea of selecting a migrational destination in terms of the processor performance and memory capacity, which will be described later, is also applicable to a case where the migrational destination is selected from among disks (volumes) and input/output devices.

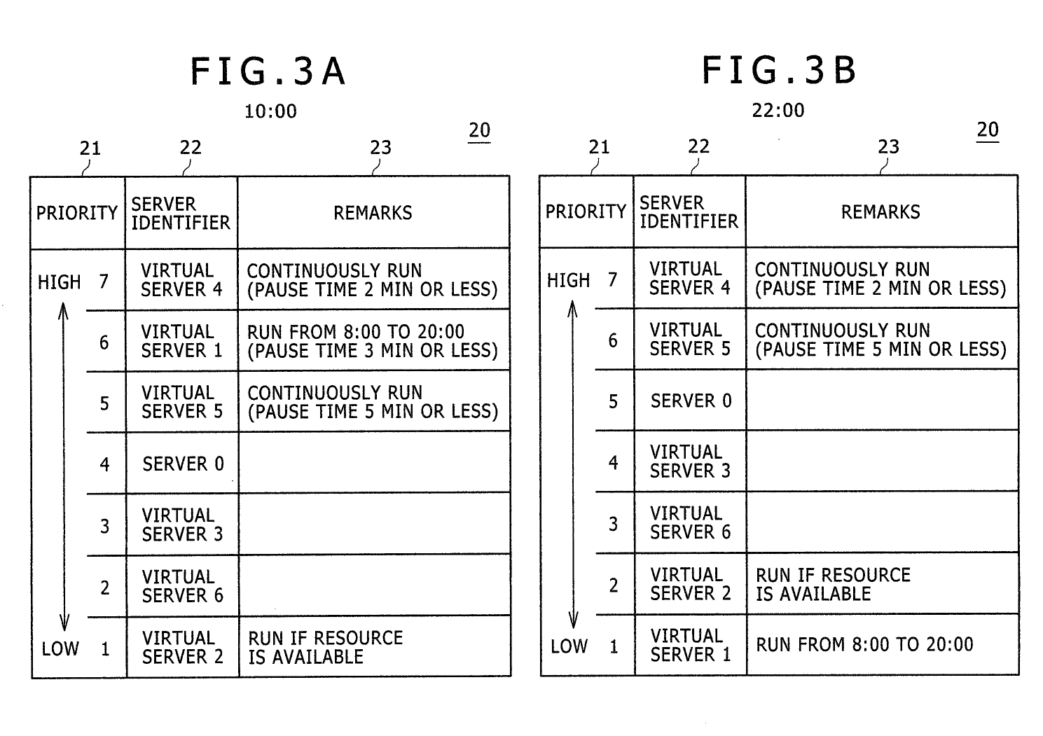

FIG. 3A and FIG. 3B show a priority information table 20 that is, similarly to the configuration information table 10, stored in the memory unit (not shown) of the management server 100. FIG. 3A shows priority information available at 10:00, and FIG. 3B shows priority information available at 22:00. In each server, plural application programs (including an online job control program and a batch processing program) are executed based on a schedule or an event arisen, and priorities are assigned to the respectively application programs. FIG. 3A and FIG. 3B are different from each other in the time in order to introduce an example that the priorities vary depending on a job (execution) schedule. For brevity's sake, one program or one set of programs shall be run in each server. The priorities of the application programs will be described by citing the priorities assigned to servers. Hereinafter, no reference will be made to the application programs, but the application programs may be thought to correspond to the servers. Otherwise, the priorities of the servers and the priorities of the application programs may be managed independently of each other, and migration of a server and migration of an application program may be executed in two stages (two layers). Consequently, even when the servers (physical serves and virtual servers) described in this specification are replaced with the application programs, the same technology can be applied.

The priority information table 20 shown in FIG. 3A has columns for a priority 21, a server identifier 22, and remarks 23. Herein, the priorities are represented by numerical values. The larger the numerical value is, the higher the priority is. Moreover, the numerical value representing the priority is not absolute, but represents a relative priority. The column for remarks 23 is used in a case where the contents of the priority information table 20 are disclosed to a system manager, and is, herein, used to supplement the purport of the priority. The examples of names and numerical values including the server identifier 22 which are shown in the priority information table 20 will be used to describe operations later. Herein, the details are omitted.

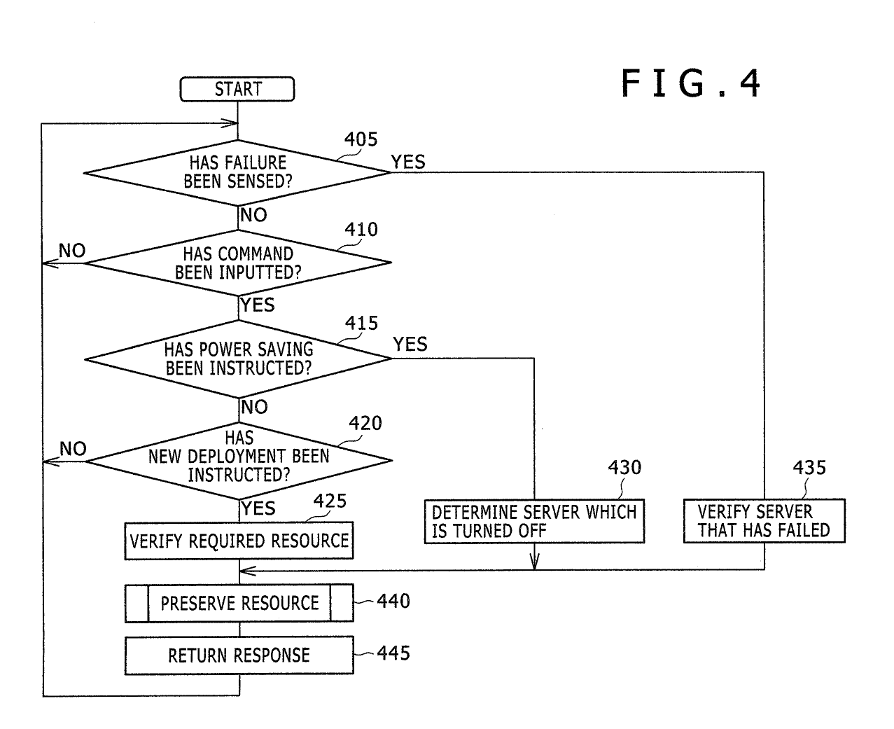

FIG. 4 is a flowchart describing as a processing program to be run by the management server 100 pieces of processing to be performed by the activation monitor unit 101, failure recovery unit 102, power saving operation unit 103, new deployment unit 104, and server arrangement unit 105 which are included in the management server 100. Events causing virtual servers to be rearranged include an operation schedule for the computer system, which can be learned from the priority information table 20 shown in FIG. 3, a load fluctuation, maintenance, and others. In the present embodiment, occurrence of a failure, an operation of power saving, and new deployment are regarded as the events. The occurrence of a failure is, similarly to an abrupt load fluctuation that is unpredictable, an example of an event relating to a physical server. The operation of power saving is an event that is regarded as a kind of operation schedule and relates to a physical server. The new deployment is an event that does not relate to a physical server but can be coped with by stopping or migrating a virtual server.

To begin with, whether a failure has occurred is decided (S405). The occurrence of a failure is sensed by checking if no failure occurrence notification is returned from each physical server or no response is returned for an inquire made by the management server 100. If a failure is sensed, the processing program proceeds to step 435. If no failure is sensed, whether a command is entered at an input device by a system manager is decided (S410). Herein, since a power saving instruction or a new deployment instruction is entered, whether a command is entered is decided. However, in the case of an operation schedule, whether a command produced by an operation schedule program is issued may be decided. If a command is entered, whether the command is the power saving instruction or new deployment instruction is decided (S415 and S420). In the case of the power saving instruction, the processing program proceeds to step 430. In the case of the new deployment instruction, the processing program proceeds to step 425. If the input command is neither the power saving instruction nor the new deployment instruction, the processing program returns to step 405.

In the case of the new deployment instruction, a required resource (processor performance and memory capacity) and a priority entered as parameters for the command are verified (S425). The parameters are used as they are, and the processing program proceeds to server arrangement processing 105 (S500). The server arrangement processing 105 will be described later. In the case of the power saving instruction, an amount of power to be saved (or a physical server identifier of a physical server that should be stopped) entered as a parameter for the command is verified (S430). The parameter is used as it is, and the processing program proceeds to the server arrangement processing 105 (S500). In case a failure is sensed, a physical server identifier of a physical server in which a failure has occurred is verified (S435). The physical server identifier is used as a parameter, and the processing program proceeds to the server arrangement processing 105 (S440). When the server arrangement processing 105 is terminated, a result of processing is notified. The result of processing is outputted as a response to an output device (S445) and thus notified a system manager.

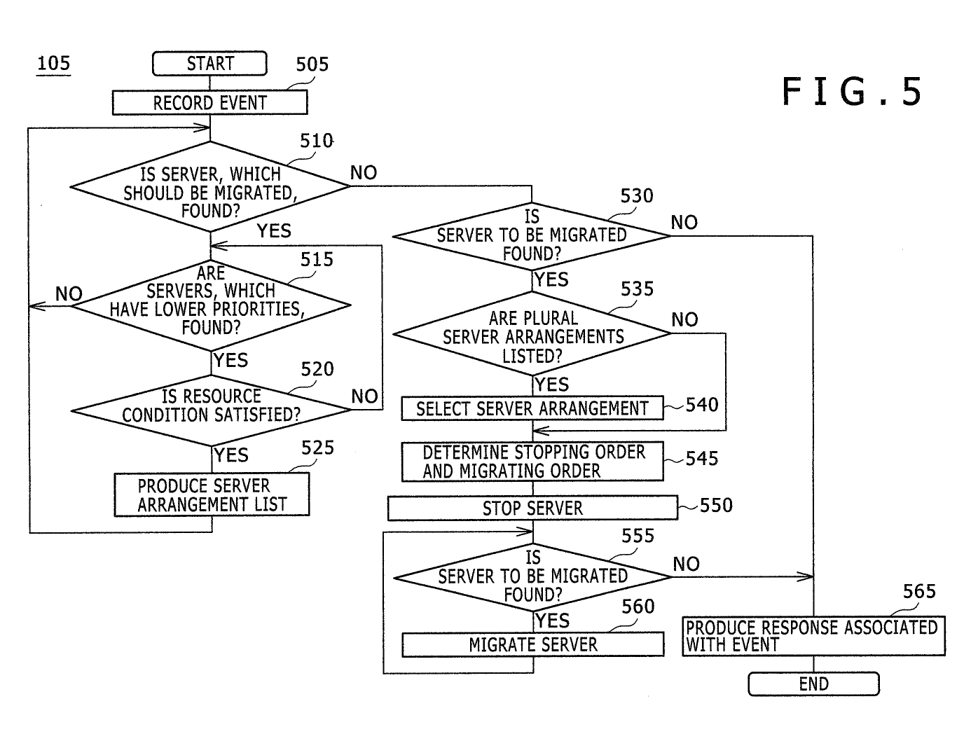

FIG. 5 is a flowchart describing server arrangement processing 105. First, the event of occurrence of a failure, instruction of power saving, or instruction of new deployment is stored together with a parameter in a predetermined area in the memory unit of the management server 100 (S505). The event, parameter, and priority information table 20 are referenced in order to decide whether a server that should be migrated is found (S510). The server that should be migrated is a server that should be migrated in order to execute processing. However, a server that should be migrated but cannot be migrated under a resource condition or the like is excluded. The priority information table 20 is referenced in order to decide whether a server having a lower priority than a server that should be migrated is found (S515). If the server having a lower priority is unfound, the processing program returns to step 510. If there are plural servers having lower priorities, a server having the highest priority is selected from among the plural servers. A resource the selected server having the lower priority uses satisfies a resource condition for a server that should be migrated is decided (S520). If the resource condition is not satisfied, the processing program returns to step 515. Whether a server having a lower priority than a previously selected server is found is decided. If the resource condition is satisfied, the server that should be migrated is added to a server position (migrational destination) that is specified in a server arrangement list and that satisfies the resource condition (S525). If plural servers having lower priorities are found at step 515, the servers are left intact as servers that should be migrated. A server that has been disposed at a migrational destination is regarded as a server that should be newly migrated, and the processing program returns to step 510.

The server arrangement list is referenced in order to decide whether a server that should be migrated is found (S530). If a server that should be migrated is unfound, unless the priorities specified in the priority information table 20 are changed, a server arrangement cannot be modified despite an event causing the server arrangement to be modified. If a server that should be migrated is unfound, the processing program proceeds to step 565.

If plural server arrangement cases are specified in the server arrangement list (S535), one case is selected from among the cases (S540). The criterion for the selection may be a criterion (1) that a case causing a small number of servers to be migrated should be selected in order to shorten a switching time required for the entire system or servers having high priorities (physical servers or virtual servers), or a criterion (2) that a large number of servers within the entire system should continuously execute a job. A description will be made later by presenting a concrete example.

When the criterion for selection (1) is applied, a time interval required for migration may vary depending on the relationship between a migrational source and a migrational destination, that is, depending on whether the migration is made from a physical server to a physical server, from a physical server to a virtual server, from a virtual server to a physical server, or from a virtual server to a virtual server. If the variation in the time interval is too large to be ignored, not only the number of times but also the time interval should be taken into consideration.

In order to shift a current server arrangement to a selected server arrangement, the order of stopping servers that should be stopped or the order of migrating servers that should be migrated is determined (S545). In the present embodiment, since the precondition for migration is occurrence of a situation in which a resource cannot be allocated to each of servers that should execute a job, there is a high possibility that any server becomes a server that should be stopped. However, although any server is not stopped, there may still be an excess of resources. In this case, a server that should be stopped may be unfound. If a server that should be stopped is found, the server is stopped (S550). If servers that should be migrated are found (S555), the servers are migrated according to the determined migrating order (S560). Steps 555 and 560 are repeated until a server that should be migrated becomes unfound. If a server that should be migrated is unfound, a response associated with the event recorded at step 505 is produced (S565).

For a profound understanding of the procedures described in the flowcharts of FIG. 4 and FIG. 5, a description will be made below by presenting a concrete example. First, a description will be made on the assumption that an event causing the physical server 0 (200) to stop arises, that is, a failure occurs in the physical server 0 (200), or an operation of power saving is instructed with the physical server 0 (200) designated as a parameter (an amount of power to be saved is designated, and a decision is made as a result that the physical server 0 (200) should be stopped). Occurrence of a failure and an operation of power saving are the different events causing the physical server 0 (200) to stop. However, the logic operation for determining a server arrangement is analogous between the events. Assuming that the current time instant is 10:00, the priority information table 20 shown in FIG. 3A is employed.

If a failure has occurred (S405), whether the physical server 0 (200) has failed is verified (S435). The processing program proceeds to server arrangement processing 105 with the physical server identifier as a parameter (S500). If power saving has been instructed, whether the physical server that should be stopped and specified as a parameter of the command is the physical server 0 (200) is verified (S430). The processing program then proceeds to the server arrangement processing 105 (S500). Occurrence of a failure or instruction of power saving is recorded as an event (S505).

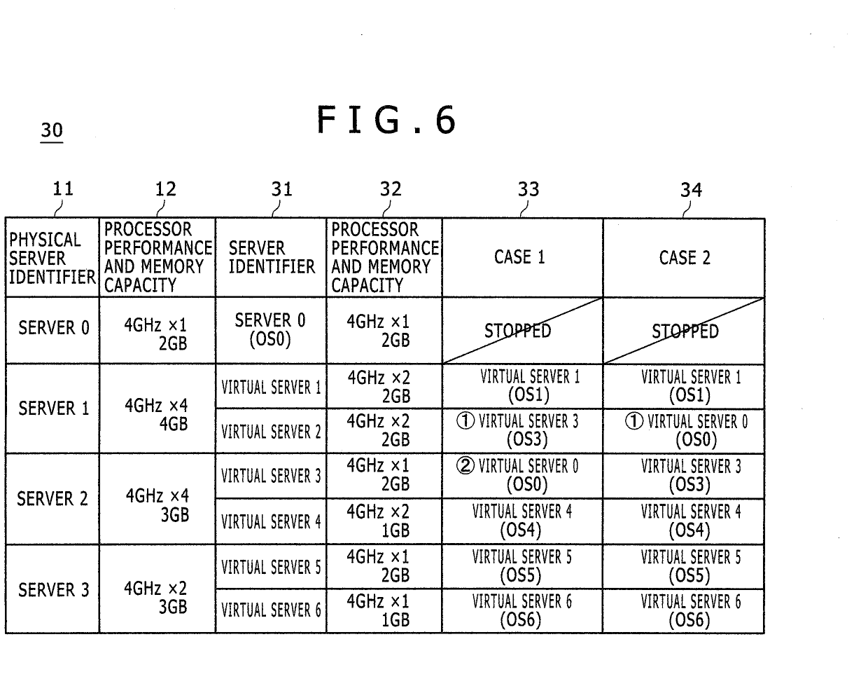

For a better understanding, the server arrangement list 30 shown in FIG. 6 will be described first. The server arrangement list 30 is a work table produced in the management server 100. The server arrangement list 30 has columns for the physical server name (identifier) 11 specified in the configuration information table 10 shown in FIG. 2, the processor performance and memory capacity 12 representing a resource for a physical server and being shown in FIG. 2, an identifier 31 of a server (physical server or virtual server) associated with an OS, and a resource 32 used by the server having the identifier 31. These columns imply the state of the server system attained before occurrence of a failure or an operation of power saving. The columns for a case 1 (33) and a case 2 (34) will be described later.

Referring back to FIG. 5, the event, parameter, and priority information table 20 are referenced in order to decide whether a server that should be migrated is found (S510). Since the physical server 0 (200) is stopped, the server that should be migrated is the server 0 that runs the OS 0. The priority information table 20 is referenced in order to decide whether servers having lower priorities than the server that should be migrated are found (S515). The virtual server 3 (222), virtual server 6 (233), and virtual server 2 (213) are detected as the servers having lower priorities than the server 0. Since plural servers have lower priorities, the virtual server 3 (222) having the highest priority is selected from among them. Whether the resource used by the virtual server 3 (222) satisfies the resource condition for the physical server 0 (200) that should be migrated is decided (S520). Since the resource used by the physical server 0 (200) includes one processor to be operated at 4 GHz and a memory having the capacity of 2G bytes, and the resource used by the virtual server 3 (222) includes one processor to be operated at 4 GHz and a memory having the capacity of 2G bytes, the resource condition is satisfied. Therefore, the case 1 column 33 is produced in the server arrangement list 30. The physical server 0 that is the server which should be migrated is specified in the case 1 column 33 in association with the resource 32 used by the virtual server 3 (222) that is included in the physical server 2 (220) and that is regarded as a server location (migrational destination) satisfying the resource condition (S525).

The processing program returns to step 510 with the virtual server 3 (222) regarded as a server that should be migrated. Whether servers having lower priorities than the virtual server 3 (222) that should be migrated are found is decided (S515). The virtual server 6 (233) and virtual server 2 (213) are detected as the servers having the lower priorities than the server 3 (222). Since plural servers have the lower priorities, the virtual server 6 (233) having the highest priority is selected from among the servers. Whether the resource used by the virtual server 6 (233) satisfies the resource condition for the virtual server 3 (222) that should be migrated is decided (S520). Since the resource used by the virtual server 3 (222) includes one processing to be operated at 4 GHz and a memory having the capacity of 2G bytes, and the resource used by the virtual server 6 (233) includes one processor to be operated at 4 GHz and a memory having the capacity of 1G bytes, the resource condition is not satisfied. The processing program therefore returns to step 515. The virtual server 2 (213) is a server having a lower priority than the virtual server 3 (222). Whether the resource used by the virtual server 2 (213) satisfies the resource condition for the virtual server 3 (222) that should be migrated is decided (S520). Since the resource used by the virtual server 3 (222) includes one processor to be operated at 4 GHz and a memory having the capacity of 2G bytes, and the resource used by the virtual server 2 (213) includes one processor to be operated at 4 GHz and a memory having the capacity of 2G bytes, the resource condition is satisfied. The virtual server 3 (222) that is a server which should be migrated is specified in the case 1 column 33 in association with the resource 32 used by the virtual server 2 (213) that is included in the physical server 1 (210) and that is regarded as a server location (migrational destination) satisfying the resource condition (S525).

As mentioned above, when plural servers having lower priorities are found at step 515, the servers are left intact as servers that should be migrated. A server disposed as a migrational destination is regarded as a server that should be migrated. The processing program then returns to step 510. As for the virtual server 3 (222), a server having a lower priority is unfound. However, since the virtual server 6 (233) and virtual server 2 (213) have lower priorities than the physical server 0 (200), the physical server 0 (200) is regarded as a server that should be migrated. The processing program then returns to step 510.

When the priority information table 20 is referenced in relation to the physical server 0 (200) that is a server which should be migrated, the servers having lower priorities than the server that should be migrated include the virtual server 6 (233) and virtual server 2 (213) but do not include the handled virtual server 3 (222) (S515). The virtual server 6 (233) having the highest priority is selected from the servers. Whether the resource used by the virtual server 6 (233) satisfies the resource condition for the physical server 0 (200) that should be migrated is decided (S520). Since the resource used by the physical server 0 (200) includes one processor to be operated at 4G bytes and a memory having the capacity of 2G bytes and the resource used by the physical server 6 (233) includes one processor to be operated at 4 GHz and a memory having the capacity of 1G bytes, the resource condition is not satisfied. The processing program then returns to step 515. The virtual server 2 (213) is a server having a lower priority than the physical server 0 (200). Whether the resource used by the virtual server 2 (213) satisfies the resource condition for the physical server 0 (200) that should be migrated is decided (S520). Since the resource used by the physical server 0 (200) includes one processor to be operated at 4 GHz and a memory having the capacity of 2G bytes, and the resource used by the virtual server 2 (213) includes one processor to be operated at 4 GHz and a memory having the capacity of 2G bytes, the resource condition is satisfied. The case 2 column 34 is therefore produced in the server arrangement list 30. The physical server 0 (200) that is a server which should be migrated is specified in the case 2 column 34 in association with the resource 32 used by the virtual server 2 (213) that is included in the physical server 1 (210) and is regarded as a server location (migrational destination) satisfying the resource condition (S525).

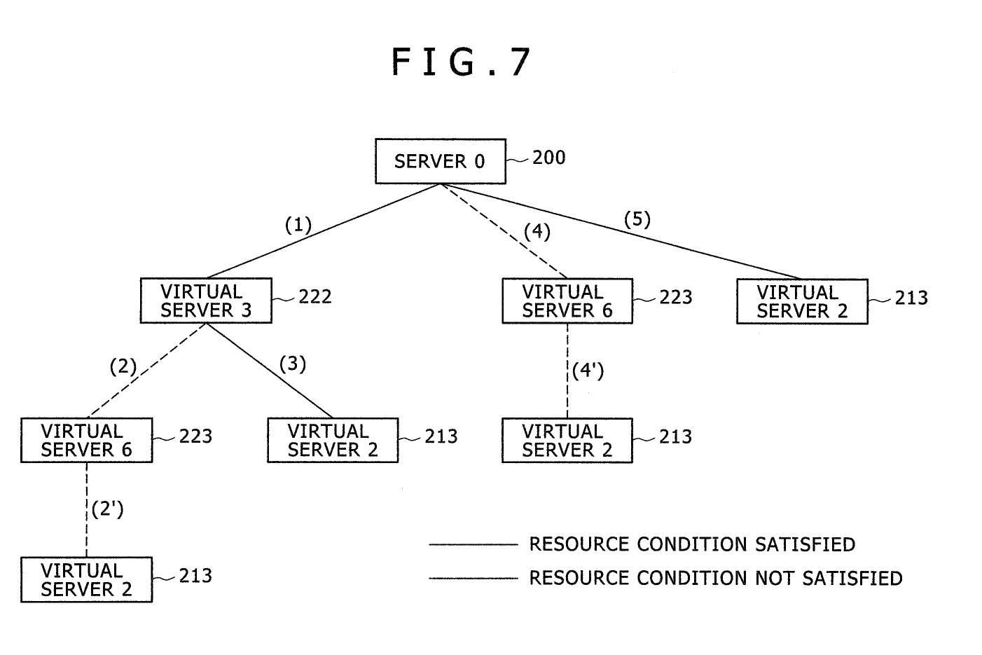

FIG. 7 shows a processing order to be followed in order to produce the foregoing server arrangement list 30. When seen from the server 0 that should be migrated first, the virtual server 3 (222), virtual server 6 (233), and virtual server 2 (213) are shown as servers, which have lower priorities than the server 0 (200), in a lower layer than the server 0 (200) from left in that order. The virtual server 6 (233) and virtual server 2 (213) are shown as servers, which have lower priorities than the virtual server 3 (222), in a lower layer than the virtual server 3 (222) from left in that order. Further, the virtual server 2 (213) is shown as a server, which has a lower priority than the virtual server 6 (233), in a lower layer than the virtual server 6 (233).

As shown in FIG. 7, the servers can be deployed in the form of a tree having the server 0 (200), which has the highest priority and should be migrated because of occurrence of an event, defined as a root node, and having the virtual server 2 (213), which has the lowest priority, defined as a leaf node. The processing from step 510 to step 525 is to search for a node, which satisfies a resource condition, in ascending order indicated with numerals in parentheses in FIG. 7. A numeral with an apostrophe signifies that since a decision is made that the upper-level server does not satisfy a resource condition, deciding whether the resource condition is satisfied is not executed. If a resource condition is satisfied, a branch between nodes is drawn with a solid line. If the resource condition is not satisfied, the branch between the nodes is drawn with a dashed line.

When search of the tree is completed, a server that should be migrated becomes unfound at step 510 in FIG. 5, and the processing program proceeds to step 530. When the server arrangement list 30 is referenced, a server that should be migrated is found (S530). Since plural server arrangement cases of the case 1 (33) and case 2 (34) are specified in the server arrangement list 30 (S535), one case is selected from the cases (S540). If the criterion for the selection is the criterion (1) that a case causing a smaller number of servers to be migrated should be selected in order to shorten a switching time required for the entire system or servers having high priorities (physical servers or virtual servers), the case 2 (34) causing the server 0 (200) alone to be migrated is selected. If the criterion is the criterion (2) that a larger number of servers (physical servers or virtual servers) within the entire system should continuously execute a job, either of the case 1 (33) and case 2 (34) may be selected. As for the criteria for selection, it may be predefined that, for example, the criteria (2) and (1) should be applied in that order. If the criteria are changed based on a situation, cases may be displayed or outputted toward the system manager so that the manager can select any of the cases.

A description will be made on the assumption that the criteria (2) and (1) are applied in that order. As mentioned above, since one of the cases cannot be selected under the criterion (2), the criterion (1) is applied and the case 2 (34) is selected. In order to modify the system configuration according to the selected case, the order of stopping servers and the order of migrating servers (indicated with encircled numerals in the server arrangement list 30) are determined (S545). Since the case 2 (34) is selected, the virtual server 2 (213) is stopped, and the server 0 (200) is migrated to the physical server 1 (210) (S555 and S560). For the migration of the server 0 to the physical server 1 (210), the server virtualization unit 211 starts the OS 0 in the disk 302 so that the OS 0 will use the resource used by the virtual server 2 (213), and thus causes the server 0 to operate as the virtual server 0. The other virtual servers continue their operations as seen from the server arrangement list 30. If the case 1 is selected, the virtual server 2 (213) is stopped as indicated with an encircled numeral in the server arrangement list 30. The virtual server 3 (222) is migrated to the physical server 1 (210), and the server 0 is migrated to the physical server 2 (220).

A response associated with the event recorded at step 505 is produced (S565). Namely, the event causing the physical server 0 (200) to stop is such that a failure has occurred in the physical server 0 (200) or an operation of power saving has been instructed with the physical server 0 (200) designated as a parameter (an amount of power to be saved is designated, and a decision is made as a result that the physical server 0 (200) should be stopped). Therefore, the contents of the response include the event and the result of modification of the system configuration (case 2 (34) in FIG. 6).

An example in which the criteria (2) and (1) are applied in that order as the criteria for selection has been described. Now, a description will be made of a case where only the criterion that a case causing a smaller number of servers to be migrated should be selected is applied. As apparent from the description made in conjunction with FIG. 7, the tree is searched by following the numerals in FIG. 7 in descending order from the largest numeral to the smallest numeral opposite to the aforesaid searching order according to a sequence different from the sequence of the logic operations of steps 510 to 525 in FIG. 5. A server having a low priority is checked to see if it is a server that should be stopped, and a server that should be migrated is migrated to the location of the server. Therefore, servers having intermediate priorities between the priority of the server that should be stopped and the priority of the server that should be migrated will not be adversely affected (need not be migrated).

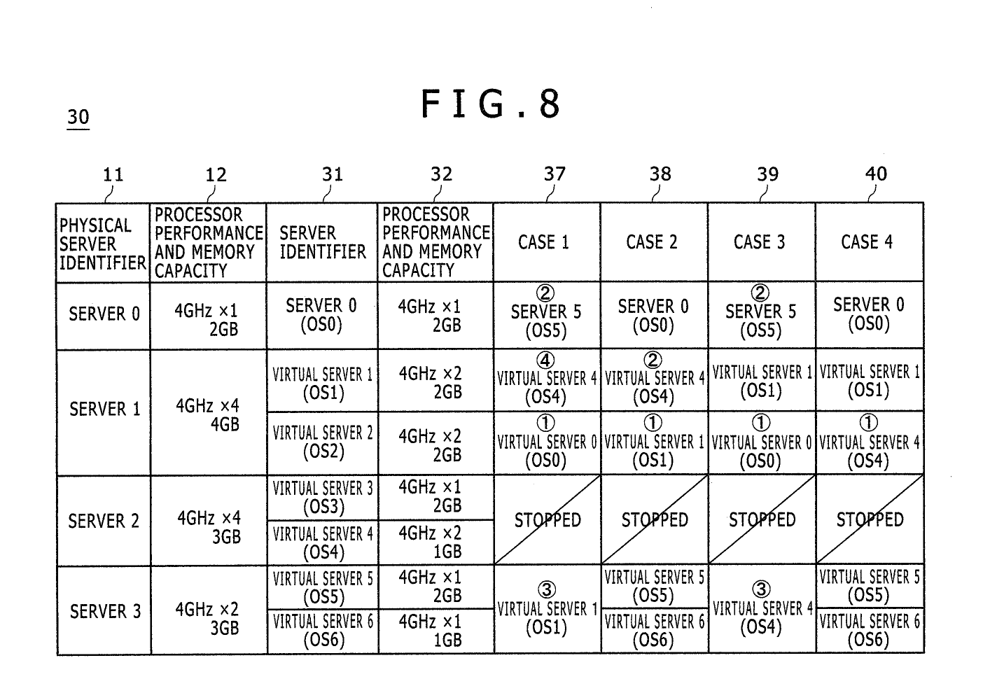

FIG. 8 shows the server arrangement list 30 produced in a case where: the event causing the physical server 2 (220) to stop has arisen, that is, a failure has occurred in the physical server 2 (220), or an operation of power saving has been instructed with the physical server 2 (220) designated as a parameter (an amount of power to be saved is designated, and a decision is made as a result that the physical server 2 (220) should be stopped). Assuming that the current time instant is 10:00, the priority information table 20 shown in FIG. 3A is employed. An iterative description of producing processing for the server arrangement list 30 is omitted. As illustrated, cases 1 to 4 (37 to 40) are produced as server arrangements. As the criteria for selection, the aforesaid criteria (2) and (1) are applied in that order. The case 2 (38) and case 4 (40) are selected by applying the criterion (2). The case 4 (40) is selected by applying the criterion (1). In the selected case 4 (40), the virtual server 2 (213) is stopped, and the virtual server 4 (223) uses the resource the virtual server 2 (213) has used.

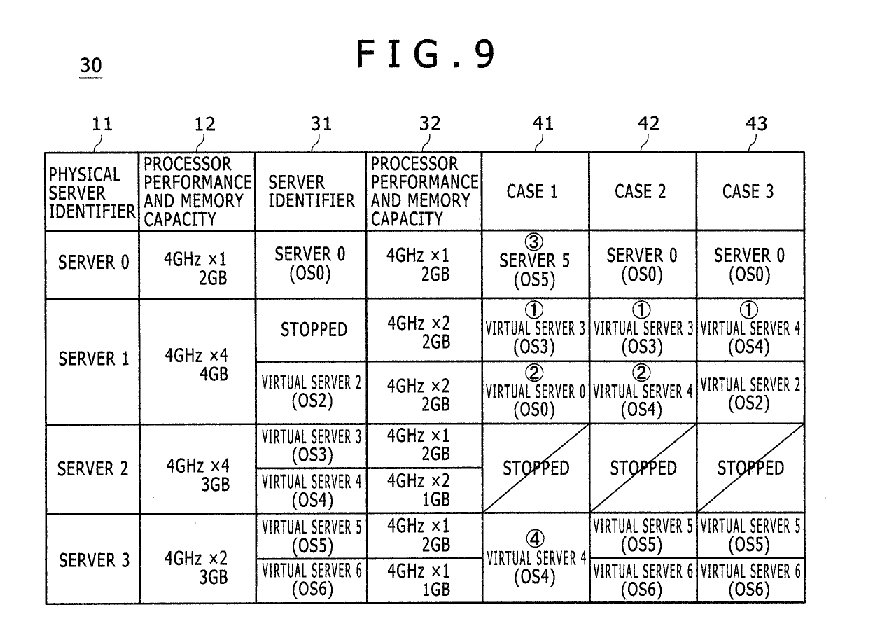

FIG. 9 shows the server arrangement list 30 produced in a case where the event causing the physical server 2 (220) to stop has arisen, that is, a failure has occurred in the physical server 2 (220), or an operation of power saving has been instructed with the physical server 2 (220) designated as a parameter (an amount of power to be saved is designated, and a decision is made as a result that the physical server 2 (220) should be stopped). A difference from FIG. 8 lies in that the current time instant is 22:00. According to the priority information table 21 shown in FIG. 3B, the virtual server 1 has stopped. An iterative description of producing processing for the server arrangement list 30 is omitted. As illustrated, cases 1 to 3 (41 to 43) are produced as server arrangements. The case 1 (41) is produced as mentioned below. The virtual server 5 (232) does not satisfy the resource condition for the virtual server 4 (223). However, since the virtual server 6 (233) included in the physical server 3 (230) in which the virtual server 5 (232) is operating has a lower priority than the virtual server 5 (232) does, whether the physical server 3 (230) satisfies the resource condition for the virtual server 4 (223) is decided at step 520 in FIG. 5.

As the criteria for selection, the aforesaid criteria (2) and (1) are applied in that order. The case 2 (42) and case 3 (43) are selected by applying the criterion (2), and the case 3 (43) is selected by applying the criterion (1). In the selected case 3 (43), the virtual server 4 uses the resource the virtual server 1 having stopped has used.

The case where an operation of power saving is instructed with a physical server designated as a parameter has been described by making, similarly to the case where a failure occurs in a physical server, it a precondition that a specific physical server should be stopped. In the system configuration shown in FIG. 1, cases (reconfiguration plans) where the respective physical servers 0 to 3 are stopped are worked out (cases for the physical server 0 are shown in FIG. 6, cases for the physical server 2 are shown in FIG. 8, and cases for the other physical servers are not shown). A criterion that a designated effect of power saving should be obtained is added to the aforesaid criteria for selection, and a case is selected from among all the cases worked out. Thus, a physical server that should be stopped can be determined. In this case, before cases are worked out, the criterion for selection that the designated effect of power saving should be obtained may be applied in order to thin the number of physical servers that are objects for working out cases.

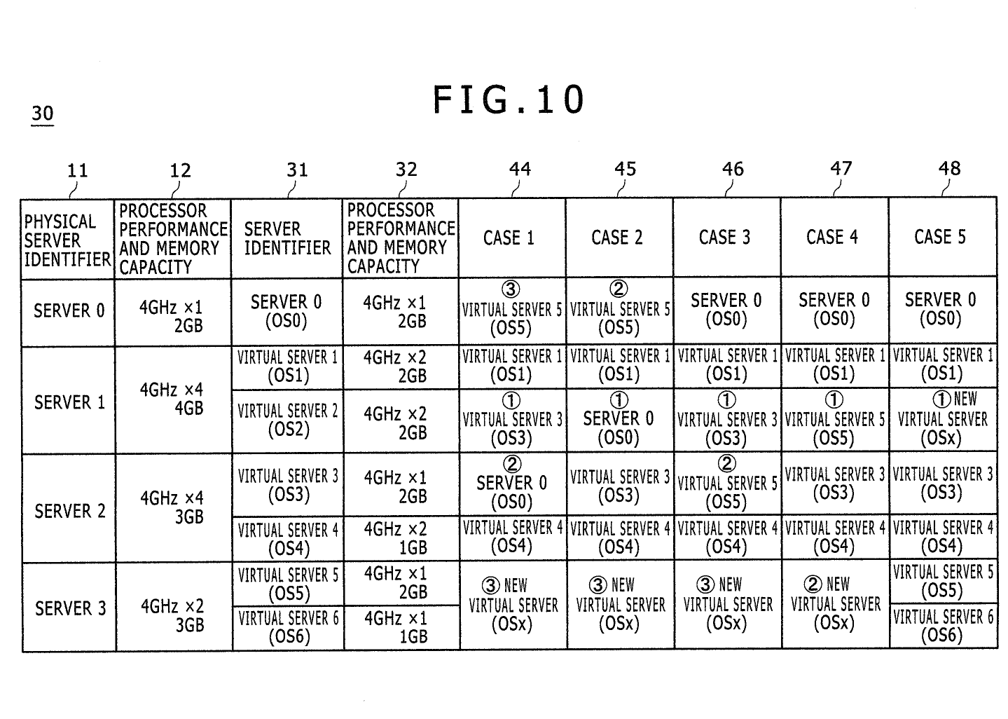

Next, a case where deployment of a new virtual server (OSx) is instructed at 10:00 with the parameters, which include the processor performance, memory capacity, and priority, set to 4 GHz×2, 2G bytes, and an intermediate value between the priorities of the virtual servers 1 and 5 respectively will be described according to the processing program mentioned in FIG. 5. FIG. 10 shows the server arrangement list 30 to be employed in a description to be made below.

Whether a server that should be migrated is found is decided (S510). Since a new virtual server is deployed, the new virtual server is regarded as the server that should be migrated. The priority information table 20 is referenced in order to decide whether servers having lower priorities than the server that should be migrated are found (S515). The virtual server 5 (232), server 0 (200), virtual server 3 (222), virtual server 6 (233), and virtual server 2 (213) are recognized as servers having lower priorities than the new virtual server. Since plural servers have lower priorities, the virtual server 5 (232) having the highest priority is selected from among the plural servers. Whether the resource used by the virtual server 5 (232) satisfies the resource condition for the new virtual server is decided (S520). The resource the new virtual server uses includes two processors to be operated at 4 GHz and a memory having the capacity of 2G bytes, and the resource the virtual server 5 (232) uses includes one processor to be operated at 4 GHz and a memory having the capacity of 2G bytes. Therefore, the resource condition is not satisfied. However, as mentioned in relation to the case 1 (41) in FIG. 9, whether the physical server 3 (230) including the virtual server 5 satisfies the resource condition is decided, and the case 1 column 44 is produced in the server arrangement list 30 in FIG. 10. The new virtual server is specified in the case 1 column 44 in association with the resource 12 of the physical server 3 (230) that is the server location satisfying the resource condition (S525).

The processing program returns to step 510, and the virtual server 5 (232) is recognized as a server that should be migrated. Whether servers having lower priorities than the virtual server 5 (232) that should be migrated are found is decided (S515). The server 0 (200), virtual server 3 (222), virtual server 6 (233), and virtual server 2 (213) are recognized as the servers having lower priorities than the server 5 (232). Since plural servers have lower priorities, the server 0 having the highest priority is selected from among the plural servers. Whether the resource the server 0 uses satisfies the resource condition for the virtual server 5 (232) that should be migrated is decided (S520). The resource the virtual server 5 (232) uses includes one processor to be operated at 4 GHz and a memory having the capacity of 2G bytes, and the resource the server 0 uses includes one processor to be operated at 4 GHz and a memory having the capacity of 1G byte. Therefore, the resource condition is satisfied. The virtual server 5 (232) that is a server which should be migrated is specified in the case 1 column 44 in association with the resource 32 of the physical server 0 that is a server location (migrational destination) satisfying the resource condition (S525).

The same processing is repeated for the server 0 (200), virtual server 3 (222), virtual server 6 (233), and virtual server 2 (213), whereby the case 1 column 45 is completed. Further, the processing is repeated for the server 0 (200), virtual server 3 (222), virtual server 6 (233), and virtual server 2 (213) that are the servers having lower priorities than the new virtual server, whereby cases 2 to 5 columns (45 to 48) are produced. The repetition of the processing will be readily understood based on the searching order for the tree described in conjunction with FIG. 7. Based on the aforesaid criteria for selection, one case is selected from among the produced plural cases 1 to 5 (44 to 48). As apparent from the server arrangement list 30 shown in FIG. 10, the case 5 (48) is selected by applying either of the aforesaid criteria for selection (1) and (2).

According to the present embodiment, reconfiguration plans (cases) coping with various events can be produced for a computer system in which an excess (redundancy) of resources is confined to a minimum necessary level. Further, when criteria for selection are applied to the reconfiguration plans, the plural reconfiguration plans can be readily compared with one another. An appropriate reconfiguration plan can be obtained based on the criteria for selection.

The present embodiment has been described in such a lo manner that the management server produces reconfiguration plans (cases) in compliance with occurrence of an event. Reconfiguration plans (cases) may be produced in advance (in offline) in association with combinations of a predicted event and a place of occurrence of the event (server or the like), and any of the reconfiguration plans may be selected with occurrence of an event. The offline processing will prove useful in a small-scale computer system, because the number of reconfiguration plans (cases) is relatively small.

In contrast, in a large-scale computer system or a computer system in which an operation schedule is often modified, typical reconfiguration plans may be produced in advance, but reconfiguration plans (cases) should preferably be produced with occurrence of an event as described in relation to the embodiment. This is because: it is hard to produce in advance reconfiguration plans that encompass all possible combinations; and a memory capacity for storage of the reconfiguration plans is limited.

What is claimed is:

1. An administration system, comprising:
a server system including a plurality of servers; and
a management server connected to the server system, monitoring an event which occurs in the server system, producing reconfiguration plans for the server system on the basis of priorities assigned to the plurality of servers and/or application programs according to the monitored event, selecting a reconfiguration plan from the reconfiguration plans under predetermined criteria, and reconfiguring the server system according to the selected reconfiguration plan.

2. The administration system according to claim 1, wherein at least one of servers included in the server system is a virtual server that operates in a physical server.

3. The administration system according to claim 2, wherein the selected reconfiguration plan includes migration of at least one of the plurality of servers and/or application programs.

4. The administration system according to claim 3, wherein the predetermined criteria includes at least one of (1) a criterion that the number of servers and/or application programs to be migrated should be small and (2) a criterion that the number of servers and/or application programs being continuously run should be large.

5. The administration system according to claim 3, wherein the priorities are relatively determined based on jobs to be executed by the plurality of servers and/or application programs included in the server system.

6. The administration system according to claim 5, wherein the priorities vary depending on an operation schedule for the server system.

7. The administration system according to claim 3, wherein the monitored event is at least one of a failure in a physical server included in the server system, an instruction of power saving in the server system, and an instruction of new deployment.

8. An administration method by using a management server connected to a server system including a plurality of servers, the method comprising the steps of:
monitoring an event which occurs in the server system;
producing reconfiguration plans for the server system on the basis of priorities assigned to the plurality of servers and/or application programs according to the monitored event;
selecting a reconfiguration plan from the reconfiguration plans under predetermined criteria; and
reconfiguring the server system according to the selected reconfiguration plan.

9. The administration method according to claim 8, wherein at least one of servers included in the server system is a virtual server that operates in a physical server.

10. The administration method according to claim 9, wherein the selected reconfiguration plan includes migration of at least one of the plurality of servers and/or application programs.

11. The administration method according to claim 10, wherein the predetermined criteria include at least one of (1) a criterion that the number of servers and/or application programs to be migrated should be small, and (2) a criterion that the number of servers and/or application programs being continuously run should be large.

12. The administration method according to claim 10, wherein the priorities are relatively determined based on jobs to be executed by the plurality of servers and/or application programs included in the server system.

13. The administration method according to claim 12, wherein the priorities vary depending on an operation schedule for the server system.

14. The administration method according to claim 10, wherein the monitored event is at least one of a failure in a physical server included in the server system, an instruction of power saving in the server system, and an instruction of new deployment.
